(19) United States
(12) Patent Application Publication
(10) Pub. No.: US 2011/0148083 A1
(43) Pub. Date: Jun. 23, 2011

(54) INFLATABLE AIRBAG ASSEMBLIES HAVING NON-PLANAR INFLATION GAS DEFLECTORS

(75) Inventors: Donald J. Paxton, Romeo, MI (US); Quin Soderquist, South Weber, UT (US); David Stites, Clarkston, MI (US)

(73) Assignee: AUTOLIV ASP, INC., Ogden, UT (US)

(21) Appl. No.: 12/643,760

(22) Filed: Dec. 21, 2009

(51) Int. Cl. B60R 21/26

(52) U.S. Cl. 280/736

(57) ABSTRACT

Inflatable airbags often have inflation gas deflectors to protect the airbag or airbag seams from sustaining damage from the force of the inflation gas and to direct the inflation gas to predetermined areas of the airbag. The deflectors can be coupled to the airbag so that the deflector projects radially away from the surface of the airbag to which the deflector is coupled. The deflectors can also have a plurality of vent apertures.

### TECHNICAL FIELD

The present disclosure relates generally to the field of automotive safety systems. More specifically, the present disclosure relates to inflatable airbag cushion assemblies having inflation gas deflectors.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the disclosure's scope, the embodiments will be described and explained with specificity and detail in reference to the accompanying drawings.

FIG. 1A is a perspective view of an airbag assembly, wherein the airbag assembly is located at a steering wheel of a vehicle and the airbag assembly is in a packaged, undeployed configuration.

FIG. 1B is a perspective view of the airbag assembly of FIG. 1A after the inflatable airbag of the airbag assembly has been deployed.

FIG. 2 is a cutaway perspective view of a portion of the airbag assembly of FIG. 1B wherein the airbag is in a deployed, inflated configuration.

FIG. 3 is a perspective view of a portion of the airbag assembly of FIG. 2.

FIG. 4 is a cross-sectional view of the airbag assembly of FIG. 1B

FIG. 5 is another cutaway perspective view of the airbag assembly of FIG. 1A.

FIG. 6 is a perspective view of a portion of another embodiment of an inflatable airbag assembly.

FIG. 7 is a perspective view of a portion of another embodiment of an inflatable airbag assembly.

### DETAILED DESCRIPTION OF PREFERRED EMBODIMENTS

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abutting” refers to items that are in direct physical contact with each other, although the items may not necessarily be attached together.

Inflatable airbag systems are widely used to minimize occupant injury in a collision scenario. Airbag modules have been installed at various locations within a vehicle, including, but not limited to, the steering wheel, the instrument panel, within the side doors or side seats, adjacent to roof rail of the vehicle, in an overhead position, or at the knee or leg position. In the following disclosure, “airbag” may refer to a front passenger airbag, a driver's airbag, or any other airbag type.

Front airbags are typically installed in the steering wheel and instrument panel of a vehicle. During installation, the airbags are rolled, folded, or both, and are retained in this packaged configuration behind a cover. During a collision event, vehicle sensors trigger the activation of an inflator, which rapidly fills the airbag with inflation gas. Thus the airbag rapidly changes confirmations from the packaged configuration to a deployed and inflated configuration.

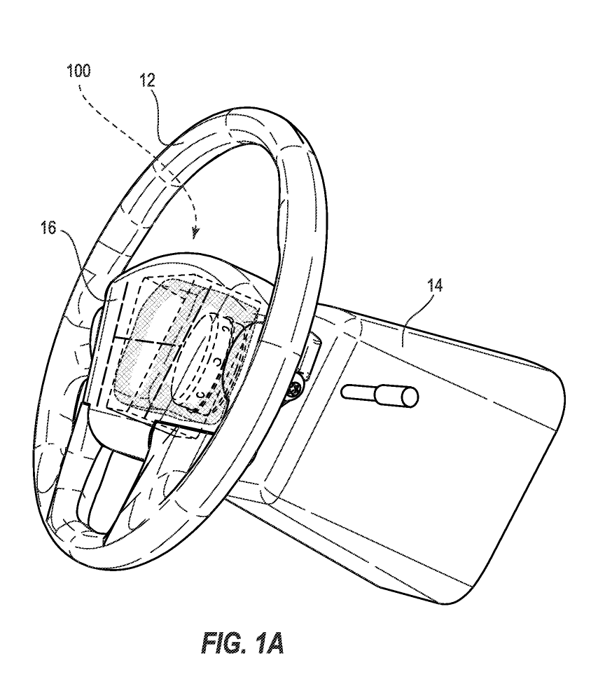

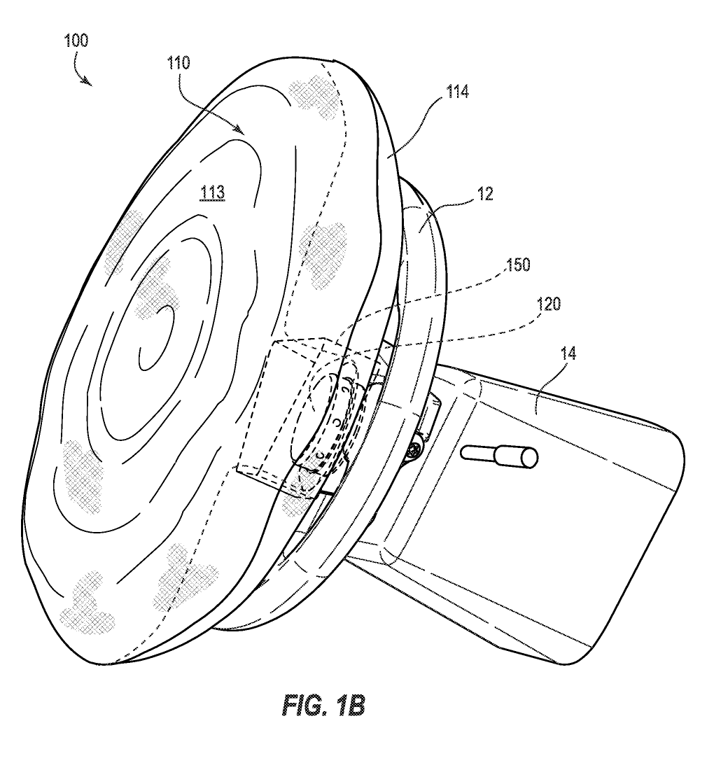

FIGS. 1A-1B depict airbag assembly 100, wherein FIG. 1A depicts airbag assembly 100 in a packaged configuration, and FIG. 1B depicts the assembly in a deployed and inflated configuration. FIGS. 1A-1B depict a steering wheel 12 and a steering column 14 of a vehicle 10. Steering wheel 12 comprises a cover 16, behind which airbag assembly 100 is located. Airbag assembly 100 may comprise an inflatable airbag 110, an inflator 120, and an airbag housing 150. Airbag 110 comprises a front panel 113, which in the deployed and inflated configuration is directed toward an occupant and may partially define a cabin side of the airbag. A rear panel 114 is located opposite front panel 113 and may define a windshield side of the airbag.

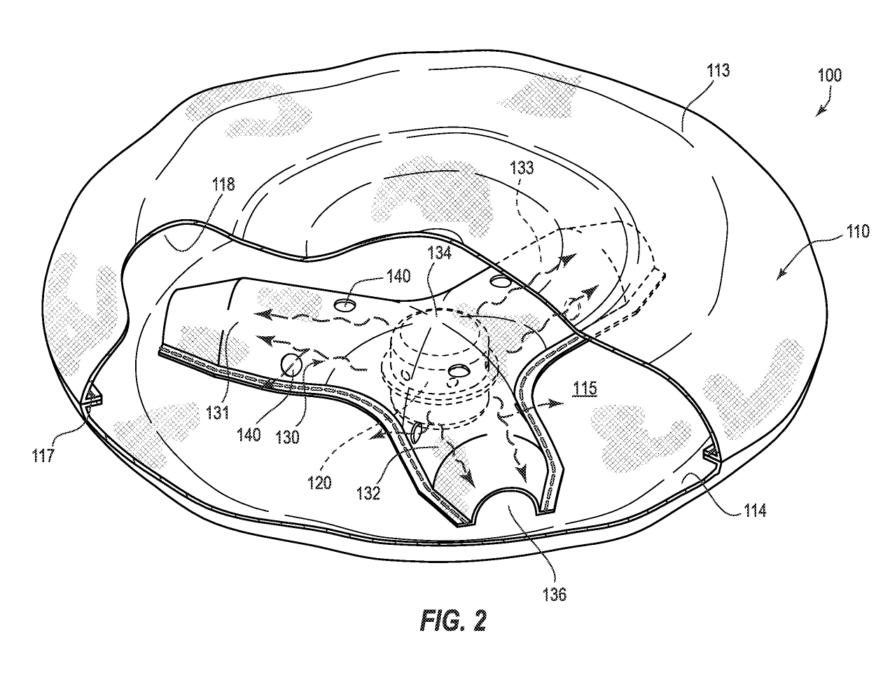

FIG. 2 depicts airbag assembly 100, from a perspective view. Airbag assembly 100 may comprise an inflatable airbag 110, an inflator 120, and an inflation gas deflector 130. Airbag assembly 100 may further comprise an airbag housing (not shown). In an undeployed state, assembly 100 may be configured to be packaged and mounted within an instrument panel or steering wheel located at the front of a vehicle. Upon activation, cushion 110 may deploy out of the instrument panel or steering wheel toward an intended occupant position in a vehicle seat.

According to the embodiment depicted in FIG. 2, cushion 110 has a front panel 113, and a rear panel 114, that are attached together at perimeter seam 117. The various panels of cushion membrane 110 define an interior inflatable void 118, which is in fluid communication with inflator 120 via deflector 130. In the depicted embodiment perimeter seam 117 is formed by stitching. Deflector 130 may comprise a woven nylon material, which may be coated with one or more materials, such as silicone. Deflector 130 may comprise a flexible fabric or a more rigid material that is still able to be folded and/or rolled into a packaged configuration. Deflector 130 may be located on an interior side 115 of rear panel 114, such that the deflector is located within inflatable void 118 of airbag 110. In the depicted embodiment, deflector 130 comprises a first arm 131, a second arm 132, a third arm 133, and a central region 134. Each arm of deflector 130 extends from central region 134 and may have a distal aperture 136. Deflector 130 may be placed in fluid communication with inflator 120.

One skilled in the art will recognize that a variety of types and configurations of deflectors can be utilized without departing from the scope and spirit of the present disclosure. For example, the size, shape, and proportions of the deflector may vary from the depicted embodiment. Also, the deflector may comprise more or fewer arms that the depiction of FIG. 2. Further, the deflector may be coupled to the airbag via a technique other than stitching.

As will be appreciated by those skilled in the art, a variety of types and configurations of airbag cushion membranes can be utilized without departing from the scope and spirit of the present disclosure. For example, the size, shape, and proportions of the cushion membrane may vary according to its use in different vehicles or different locations within a vehicle such that the cushion may comprise an inflatable cushion; a rear passenger side airbag; a driver's airbag; and/or a front passenger airbag. Also, the cushion membrane may comprise one or more pieces of any material well known in the art, such as a woven nylon fabric. Additionally, the airbag cushion may be manufactured using a variety of techniques such as one piece weaving, “cut and sew”, or a combination of the two techniques. Further, the cushion membrane may be manufactured using sealed or unsealed seams, wherein the seams are formed by stitching, adhesive, taping, radio frequency welding, heat sealing, or any other suitable technique or combination of techniques.

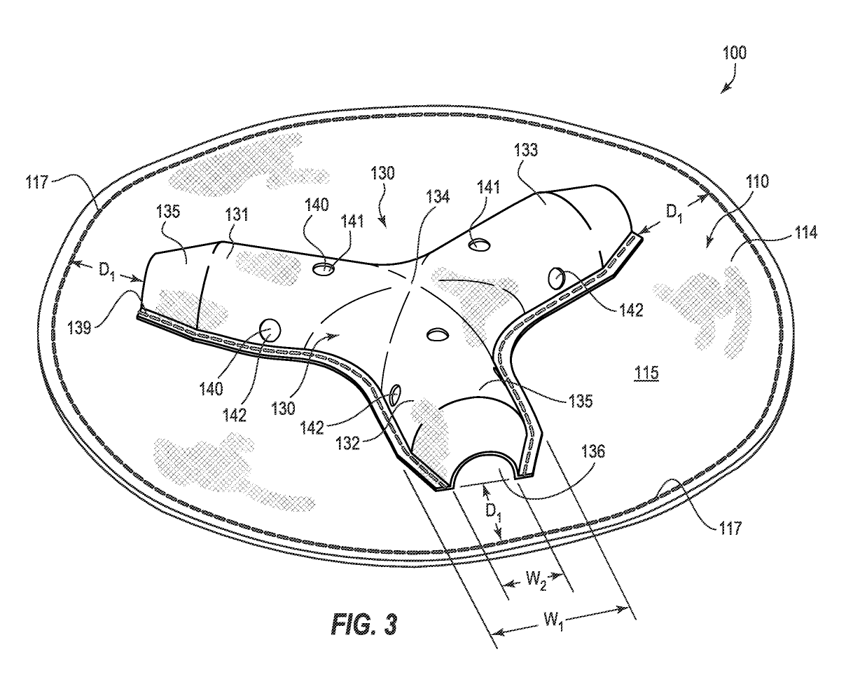

FIG. 3 depicts a perspective view of a portion of airbag assembly 100. The front panel of airbag 110 has been removed such that more of deflector 130 is visible; however, for clarity, perimeter seam 117 has been added to the figure. As described above, deflector 130 is located on inner side 115 of rear panel 114 and is in fluid communication with the inflator. Deflector 130 comprises a central region 134, which may be located above the inflator. Three arms, 131, 132, and 133 radiate outward from central region 134. Each arm 131, 132, and 133 comprises a distal portion 135, a distal aperture 136 and vents 140. Vents 140 may comprise two species of vents: top vents 141 and side vents 142.

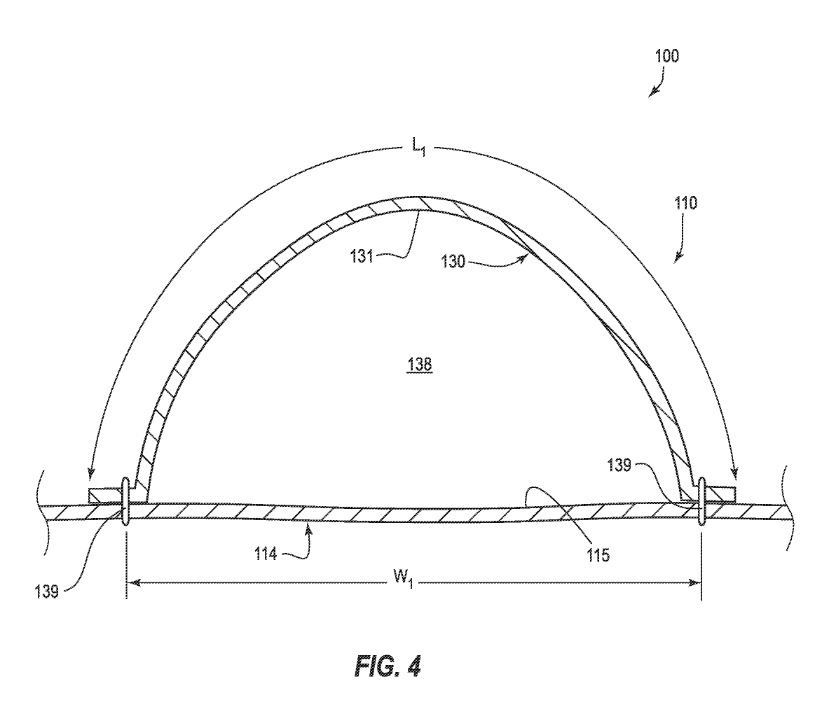

Top vents 141 may be configured such that they direct inflation gas toward front panel 113 of inflatable airbag 110. In one embodiment, top vents 141 direct inflation gas toward front panel 113 in a direction that is substantially perpendicular to the front panel, when the front panel is in a deployed and inflated configuration, such as is depicted in FIGS. 2 and 4. In some embodiments, top vents 141 may be configured such that the top vents only direct inflation gas toward front panel 113 in a direction that is substantially perpendicular to the front panel, when airbag 110 and front panel 113 are in a deployed and inflated configuration, such as is depicted in FIGS. 2 and 4.

Side vents 142 may be configured such that they direct inflation gas toward a periphery of inflatable airbag 110. The periphery of airbag 110 may be defined as perimeter seam 117, or in embodiments that lack a perimeter seam, the periphery may be defined as a “side” portion of the airbag. In one embodiment, side vents 142 direct inflation gas toward perimeter seam 117. In some embodiments side vents 142 direct inflation gas toward perimeter seam 117 in a direction that is substantially perpendicular to the perimeter seam, when the airbag is in a deployed and inflated configuration, such as is depicted in FIGS. 2 and 4. In some embodiments, side vents 142 may be configured such that the side vents only direct inflation gas toward perimeter seam 117 in a direction that is substantially perpendicular to the perimeter seam, when airbag 110 is in a deployed and inflated configuration, such as is depicted in FIGS. 2 and 4. In other embodiments, the side vents may be configured to direct inflation gas in one or more directions that may or may not include the front panel and/or the periphery of the airbag.

One skilled in the art will recognize that in a packaged configuration, the top and side vents may not be directed toward the front panel and periphery of airbag 110, respectively. Further, in early stages of airbag deployment, the airbag and deflector may comprise rolls, folds, and/or wrinkles such that the top and side vents may not be directed toward the front panel and periphery of airbag 110, respectively. However, once the deflector is in an inflated configuration, such as depicted in FIGS. 2-4, one skilled in the art will recognize that the top and side vents may direct inflation gas toward what will become the front and periphery of the airbag, once the airbag is in a deployed and inflated configuration.

Arms 131, 132, and 133 may have identical, similar, or disparate features. In the depicted embodiment, arms 131, 132, and 133 each extend to a predetermined location, such that their distal apertures 136 are a predetermined distance D₁ from perimeter seam 117. Distance D₁ may comprise a range from about 10 mm to about 200 mm. Also, distance D₁ may not be the same for each arm of the deflector.

The material that forms each arm 131, 132, and 133, as well as central region 134 has a width that is greater than a width W₁, defined by a deflector attachment seam 139. In other words, the material of deflector 130 is not pulled tightly by its attachment seam such that the deflector comprises a planar shape. Rather, there is slack in the material of deflector 130, such that even when inflation gas is not passing through the deflector, the deflector comprises a non-planer, three-dimensional shape, although that shape may vary from the depictions of the figures herein.

Distal apertures 136 of each of arms 131, 132, and 133 may comprise a smaller width W₂ than width W₁. In other words, the distal ends of the arms of the deflector may be partially closed, such that the distal aperture has a smaller diameter or width than the rest of the arm. As such, less inflation gas can escape through the distal aperture than if the distal aperture did not have a reduced width. One skilled in the art will recognize that the amount of inflation gas that can escape through the distal aperture can be reduced in a number of ways. In the depicted embodiment, the distal portion of each of the arms is tapered; however in other embodiments, the distal portion may simply be folded, or the width W₁ of the stitching may be reduced, rather than the width of the fabric. Width W₁ may comprise a range from about 75 mm to about 300 mm. Width W₂ may comprise a range from about 25% to about 50% of width W₁, such that width W₂ may comprise a range from about 37 mm to about 150 mm. In other embodiments the distal portion of each arm may not be reduced such that the distal aperture comprises a full width of the deflector arm.

FIG. 4 is a cross-sectional view of a portion of airbag assembly 100. Arm 131 of deflector 130 is coupled on inner side 115 of rear panel 114 via stitching 139 to form inflatable void 138. Inflatable void 138 may be called a second inflatable void, wherein the first inflatable void is defined by front and rear panels 113 and 114 of airbag 110. The material from which arm 131 is formed comprises a length L₁, that is defined by a distance between attachment points (sew lines) 139. Width W₁ is defined by a distance between stitching 139. Length L₁ comprises a magnitude that is greater than W₁, such that arm 131 of deflector 130 comprises a non-planar shape, even when inflation gas is not passing through inflatable void 138.

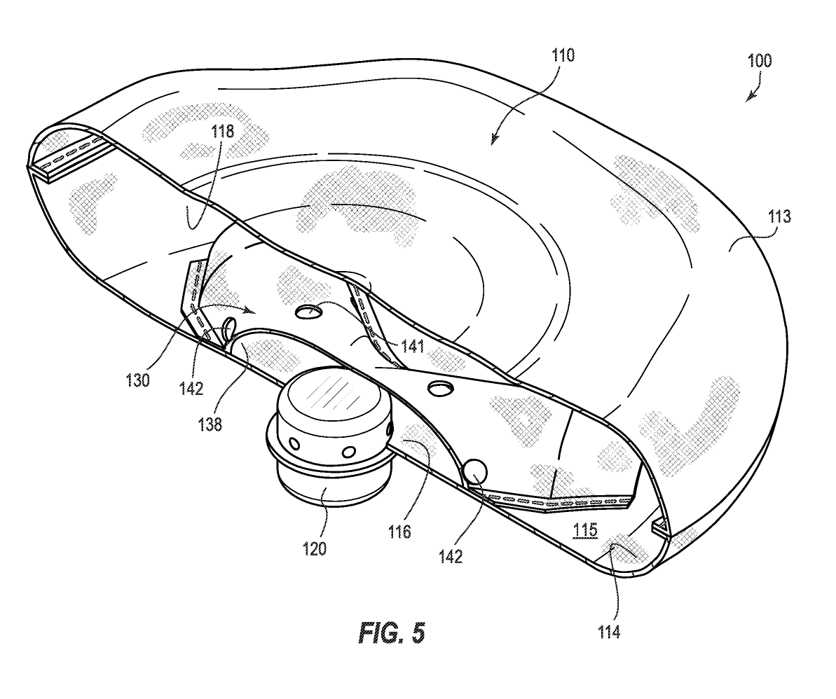

FIG. 5 depicts a cutaway perspective view of airbag assembly 100, wherein airbag 110 and deflector 130 have been partially cutaway to reveal inflator 120. Front panel 113 and rear panel 114 are coupled together to form inflatable void 118. Deflector 130 is coupled to inner side 115 of rear panel 114, such that a second inflatable void 138 is formed. Inflatable void 118 is in fluid communication with inflator 120 via vent apertures 136, 141, and 142 of deflector 130. Inflator 120 is in fluid communication with inflatable void 138 because a gas-emitting portion of the inflator protrudes into the inflatable void via a throat portion 116 of airbag 110. Throat portion 116 may be an integral portion of rear panel 114, or the throat portion may comprise an extension of, or an extension from the rear panel.

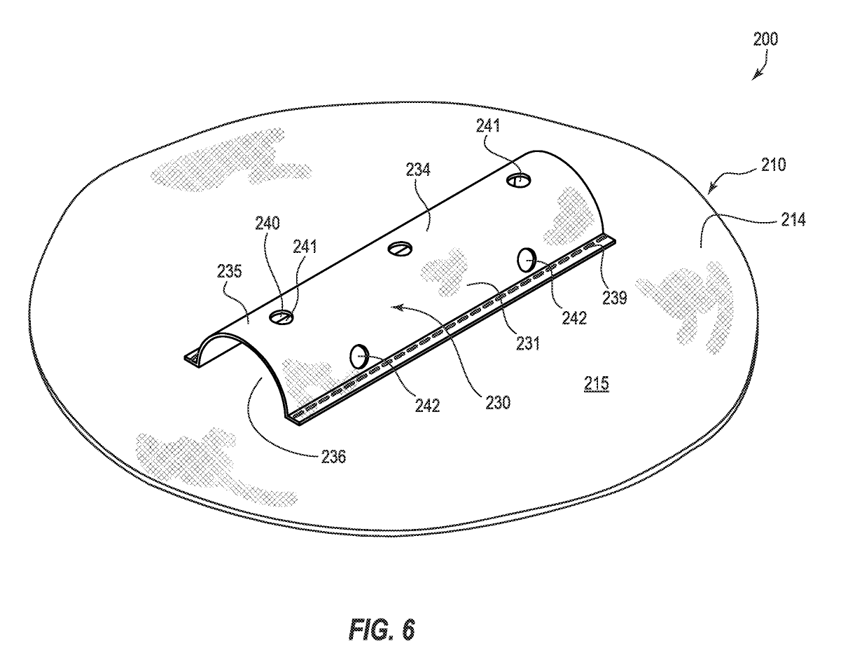

FIG. 6 is a perspective view of a portion of airbag assembly 200 with a deflector 230, wherein the airbag assembly 200 and the deflector 230 resemble airbag assembly 100 and deflector 130, described above, in certain respects. Accordingly, like features may be designated with like reference numerals, with the leading hundreds numeral incremented from “1” to “2”. Any suitable combination of the features described with respect to airbag assembly 100 and deflector 130 can be employed with assembly 200 and deflector 230, and vice versa.

In the view of FIG. 6, a front panel of airbag 210 has been removed. Airbag assembly 200 may comprise an inflatable airbag 210 and deflector 230. Airbag 210 may be configured similarly, and may function similarly as airbag 110, described herein, wherein airbag 210 comprises a rear panel 214. Deflector 230 is coupled to an inner side 215 of rear panel 214 at seam 239 to form an inflatable void. In the depicted embodiment, seam 239 comprises stitching. Deflector 230 comprises an “I” shape, having a central portion 234 and two opposing distal portions 235. Each distal portion 235 has a distal aperture 236, which in the depicted embodiment is not narrowed compared to the rest of the deflector, as are distal apertures 136, described herein. Deflector 230 may comprise a plurality of vents 240, which may comprise two species: top vents 241 and side vents, 242. In other embodiments, the side vent apertures may be configured to direct inflation gas in one or more directions that may or may not include the front panel and/or the periphery of the airbag.

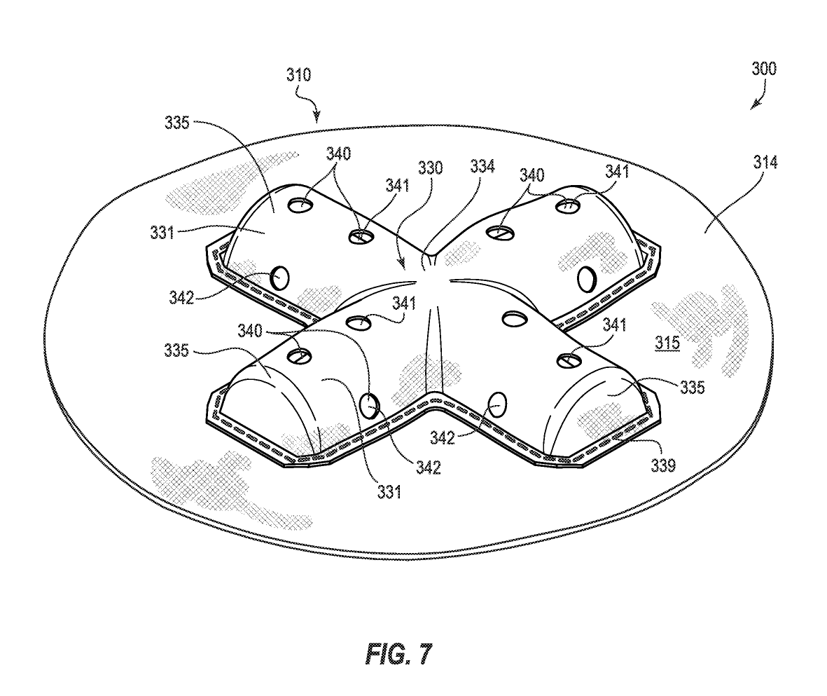

FIG. 7 is a perspective view of a portion of airbag assembly 300 with a deflector 330, wherein the airbag assembly 300 and the deflector 330 resemble airbag assemblies 100 and 200 and deflectors 130 and 230, described above, in certain respects. Accordingly, like features may be designated with like reference numerals, with the leading hundreds numeral incremented from “1” or “2” to “3”. Any suitable combination of the features described with respect to airbag assemblies 100 and 200 and deflectors 130 and 230 can be employed with assembly 300 and deflector 330, and vice versa.

In the view of FIG. 7, a front panel of airbag 210 has been removed. Airbag assembly 300 may comprise an inflatable airbag 310 and deflector 330. Airbag 310 may be configured similarly, and may function similarly as airbag 110, described herein, wherein airbag 310 comprises a rear panel 314. Deflector 330 is coupled to an inner side 315 of rear panel 314 at seam 339 to form an inflatable void. In the depicted embodiment, seam 339 comprises stitching. Deflector 330 comprises an “X” shape, having a central portion 334 and four arms 331. Each arm 331 has a distal portion 335. Each distal portion 335 lacks a distal aperture like those of deflectors 130 or 230, described herein. Distal portions 335 are closed such that inflation gas may primarily escape the inflatable void of deflector 330 via vent apertures 340. Vent apertures 340 may comprise two species: top vents 341 and side vents 342. In other embodiments, the side vent apertures may be configured to direct inflation gas in one or more directions that may or may not include the front panel and/or the periphery of the airbag. In some embodiments, seam 339 may comprise a sealed seam such that inflation gas can only escape the inflatable void of deflector 330 via vent apertures 340.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. §112 ¶ 6. It will be apparent to those having skill in the art that changes may be made to the details of the above-described embodiments without departing from the underlying principles of the invention. Embodiments of the invention in which an exclusive property or privilege is claimed are defined as follows.

1. An inflatable airbag assembly, comprising:
an inflatable airbag having a front panel and a rear panel that form an inflatable void;
an inflator coupled to the rear panel of the airbag such that the inflator is in fluid communication with the inflatable void of the airbag; and
an inflation gas deflector coupled to an inside surface of the rear panel of the inflatable airbag via a plurality of seams, such that the deflector is located within the inflatable void of the airbag, wherein the deflector and the rear panel of the airbag form a second inflatable void that is in fluid communication with the inflator, and
wherein a material from which second inflatable void is formed comprises a width between coupling seams that is greater than a width of the coupling seams themselves, such that the deflector comprises a non-planar shape even when inflation gas is not passing through the second inflatable void.

2. The inflatable airbag assembly of claim 1, wherein the deflector is configured to only direct inflation gas toward a periphery of the inflatable airbag and in a direction that is substantially perpendicular to the front panel of the inflatable airbag, with respect to an inflated configuration of the airbag.

3. The inflatable airbag assembly of claim 1, wherein the second inflatable void is partially formed into an arm by partially parallel seams, and wherein the arm extends toward a periphery of the inflatable airbag.

4. The inflatable airbag assembly of claim 3, wherein the deflector arm comprises a distal aperture that directs inflation gas toward the periphery of the inflatable airbag.

5. The inflatable airbag assembly of claim 3, wherein the deflector arm lacks a distal aperture.

6. The inflatable airbag assembly of claim 3, wherein the deflector arm comprises a plurality of vent apertures, and wherein each of the vent apertures are configured to either direct inflation gas toward the periphery of the inflatable airbag or toward the front panel of the inflatable airbag, with respect to an inflated configuration of the airbag.

7. The inflatable airbag assembly of claim 3, wherein the deflector arm extends toward the periphery to within a range of about 10 mm to about 200 mm of a perimeter seam of the airbag.

8. The inflatable airbag assembly of claim 3, wherein the deflector comprises an “I” shape.

9. The inflatable airbag assembly of claim 3, wherein the deflector comprises a “Y” shape.

10. The inflatable airbag assembly of claim 3, wherein the deflector comprises an “X” shape.

11. An inflatable airbag assembly, comprising:
an inflatable airbag having a front panel and a rear panel that form an inflatable void;
an inflator coupled to the rear panel of the airbag such that the inflator is in fluid communication with the inflatable void of the airbag; and,
an inflation gas deflector coupled to an inside surface of the rear panel of the inflatable airbag via a plurality of seams, such that the deflector is located within the inflatable void of the airbag, wherein the deflector and the rear panel of the airbag form a second inflatable void that is in fluid communication with the inflator, and
wherein a material from which second inflatable void is formed comprises a width between coupling seams that is greater than a width of the coupling seams themselves, such that the deflector comprises a non-planar shape even when inflation gas is not passing through the second inflatable void, and
wherein the second inflatable void is partially formed into an arm by partially parallel seams, and
wherein the deflector arm comprises a distal aperture that directs inflation gas toward the periphery of the inflatable airbag, and
wherein the distal aperture of the deflector arm has a reduced width compared to a body portion of the arm.

12. The inflatable airbag assembly of claim 11, wherein the deflector arm extends toward the periphery to within a range of about 10 mm to about 200 mm of a perimeter seam of the airbag.

13. The inflatable airbag assembly of claim 11, wherein the deflector arm lacks a distal aperture.

14. The inflatable airbag assembly of claim 11, wherein the deflector comprises an “I” shape.

15. The inflatable airbag assembly of claim 11, wherein the deflector comprises a “Y” shape.

16. The inflatable airbag assembly of claim 11, wherein the deflector comprises an “X” shape.

17. An inflatable airbag assembly, comprising:
an inflatable airbag having a front panel and a rear panel that form an inflatable void;
an inflator coupled to the rear panel of the airbag such that the inflator is in fluid communication with the inflatable void of the airbag; and,
an inflation gas deflector coupled to an inside surface of the rear panel of the inflatable airbag via a plurality of seams, such that the deflector is located within the inflatable void of the airbag, wherein the deflector and the rear panel of the airbag form a second inflatable void that is in fluid communication with the inflator, and
wherein a material from which second inflatable void is formed comprises a width between coupling seams that is greater than a width of the coupling seams themselves, such that the deflector comprises a non-planar shape even when inflation gas is not passing through the second inflatable void, and
wherein the deflector is configured to only direct inflation gas toward a periphery of the inflatable airbag and in a direction that is substantially perpendicular to the front panel of the inflatable airbag, with respect to an inflated configuration of the airbag, and
wherein the second inflatable void is partially formed into an arm by partially parallel seams, and
wherein the deflector arm comprises a distal aperture that directs inflation gas toward the periphery of the inflatable airbag, and
wherein the distal aperture of the deflector arm has a reduced width compared to a body portion of the arm.

18. The inflatable airbag assembly of claim 17, wherein the deflector arm lacks a distal aperture.

19. The inflatable airbag assembly of claim 17, wherein the deflector arm comprises a plurality of vent apertures, and wherein each of the vent apertures are configured to direct inflation gas toward the periphery of the inflatable airbag or toward the front panel of the inflatable airbag, with respect to an inflated configuration of the airbag.

20. The inflatable airbag assembly of claim 17, wherein the deflector arm extends toward the periphery to within a range of about 10 mm to about 200 mm of a perimeter seam of the airbag.

21. The inflatable airbag assembly of claim 17, wherein the deflector comprises an “I” shape.

22. The inflatable airbag assembly of claim 17, wherein the deflector comprises a “Y” shape.

23. The inflatable airbag assembly of claim 17, wherein the deflector comprises an “X” shape.
